(19) United States
(12) Patent Application Publication
(10) Pub. No.: US 2026/0010459 A1
(43) Pub. Date: Jan. 8, 2026

(54) METHOD AND SYSTEM FOR HUMAN-COMPUTER INTERACTION PERFORMANCE EVALUATION BASED ON VIRTUAL REALITY

(71) Applicant: China National Institute of Standardization, Beijing (CN)

(72) Inventors: Chaoyi Zhao, Beijing (CN); Linghua Ran, Beijing (CN); Zhongting Wang, Beijing (CN); Wei Li, Beijing (CN); Huimin Hu, Beijing (CN); Haimei Wu, Beijing (CN); He Zhao, Beijing (CN); Yue He, Beijing (CN); Yunhong Zhang, Beijing (CN)

(21) Appl. No.: 19/209,694

(22) Filed: May 15, 2025

(30) Foreign Application Priority Data
Jul. 5, 2024 (CN) 202410896248.4

(51) Int. Cl. G06F 11/3604

(52) U.S. Cl. CPC G06F 11/3612

(57) ABSTRACT

Disclosed are a method and system for human-computer interaction performance evaluation based on virtual reality. The method includes: evaluating a response speed, accuracy and processing efficiency of a human-computer interaction system by collecting and analyzing data of operating behaviors of the user throughout task execution, which helps to improve overall performance and efficiency of the human-computer interaction system; evaluating human-computer interaction performance, to timely discover problems and deficiencies in the design of the human-computer interaction system and identify difficulties and bottlenecks encountered by the user during task execution in a virtual reality environment, so as to optimize a human-computer interaction interface design, interaction logic and operation process, and improve the user's interaction experience in the virtual environment; and optimizing the human-computer interaction performance of a human-computer interaction device, to reduce erroneous interactions between the user and the device, so as to enhance user satisfaction with human-computer interaction.

### CROSS-REFERENCE TO RELATED APPLICATION

This application claims priority of Chinese Patent Application No. 202410896248.4, filed on Jul. 5, 2024, the entire contents of which are incorporated herein by reference.

### TECHNICAL FIELD

The present disclosure relates to the technical field of human-computer interaction performance data processing, and in particular to a method and system for human-computer interaction performance evaluation based on virtual reality.

### BACKGROUND

At present, evaluation of human-computer interaction performance relies on interaction performance evaluation indicators obtained in the human-computer interaction process. When the interaction performance is insufficiently analyzed in the human-computer interaction process, evaluation of the human-computer interaction performance will be affected, and interaction response, human-computer interaction and the like will be delayed and restricted.

For example, the invention patent with the publication No. CN113282475B relates to the technical field of human-computer interaction, and discloses a method and apparatus for evaluating interaction performance of an interaction system. The method for evaluating interaction performance of an interaction system includes: obtaining an interaction state of each interaction log of the interaction system, and labeling each log according to the interaction state; and determining a self-learning index of the interaction system according to a labeling result of each log to evaluate the interaction performance of the interaction system. The method for evaluating interaction performance of an interaction system can be used to evaluate a dynamic process of improving the performance of the interaction system by means of self-learning. An apparatus for evaluating interaction performance of an interaction system is further disclosed.

For example, the invention patent with publication No. CN116361130A discloses an evaluation method based on a virtual reality human-computer interaction system, and relates to the technical field of virtual reality. The method includes: acquiring task completion indicators to evaluate task execution and establishing an interactive digital twin model; creating a system response dataset and deriving a functional ratio Gnb according to a proportion of interaction efficiency coefficients Jxs exceeding a corresponding threshold; constructing a performance detection dataset, correlating same to generate a performance evaluation coefficient Nxs, and calculating a performance ratio Xnb according to the proportion of a plurality of interaction efficiency coefficients Jxs exceeding the corresponding threshold; fitting a change trend of an interaction coefficient jHxs and outputting a resulting jHxs fitting function; associatively obtaining the interaction coefficient jHxs; assessing an operational risk of the interaction system, issuing an early warning, and outputting risk nodes and corresponding response strategies; selecting a corresponding response strategy from a response strategy database according to abnormal parameters, and outputting the response strategy based on evaluation and prediction to realize timely intervention in the event of a potential operational risk.

Combined with the above technical solutions, it is found that reliability analysis of human-computer interaction performance directly impacts performance evaluation, and sole performance evaluation on complex human-computer interaction scenarios may result in a large error between an outcome of evaluated human-computer interaction performance and that of actual human-computer interaction performance, thereby failing to enhance operational efficiency in the human-computer interaction.

### SUMMARY

In order to overcome the defects of the prior art, the present disclosure provides a method and system for human-computer interaction performance evaluation based on virtual reality, which effectively solves the technical problems mentioned in the above Background.

In order to achieve the above objective, the present disclosure is achieved by the following technical solution: in a first aspect, the present disclosure provides a method for human-computer interaction performance evaluation based on virtual reality, and the method includes: collecting and analyzing human-computer interaction data: in a virtual reality environment, controlling a user to execute an interaction task through a human-computer interaction device, collecting and analyzing behavioral data of the user during task execution, collecting and analyzing interaction data of the human-computer interaction device during task control, and deriving a user behavior interaction index and a device interaction performance index.

Evaluating human-computer interaction performance: comprehensively analyzing the user behavior interaction index and the device interaction performance index to obtain a human-computer interaction performance evaluation indicator.

Optimizing the human-computer interaction: comparing the human-computer interaction performance evaluation indicator with a preset human-computer interaction performance evaluation indicator, matching a human-computer interaction performance optimization solution, and finally optimizing the human-computer interaction performance of the human-computer interaction device.

As a further optimization of the method, the behavioral data of the user during task execution specifically includes a total interaction duration of the user during task execution, the number of user interactions during task execution, a maximum heart rate of the user during task execution, and a respiratory rate of the user during task execution.

As a further optimization of the method, the user behavior interaction index is specifically analyzed as follows:
interaction efficiency of the user during task execution, the maximum heart rate of the user during task execution, and an average respiratory rate of the user during task execution are comprehensively analyzed to obtain the user behavior interaction index.

As a further optimization of the method, the interaction data of the human-computer interaction device during the task control specifically includes: a task interaction response duration of the human-computer interaction device, a task interaction execution duration, a total number of interaction tasks executed, the number of interaction tasks properly executed, and a duration when interaction tasks are properly executed during the task control.

As a further optimization of the method, the device interaction performance index is specifically analyzed as follows:
an interaction task execution completion duration, an interaction task execution accuracy rate, and an interaction task execution time accuracy rate are comprehensively processed to obtain the device interaction performance index.

As a further optimization of the method, the human-computer interaction performance evaluation indicator is specifically analyzed as follows:
the user behavior interaction index and the device interaction performance index are comprehensively analyzed to obtain the human-computer interaction performance evaluation indicator, with a specific analysis formula as follows:

$$\partial = \frac{{e}^{ρ * {m}_{1}} + {e}^{d i * {m}_{2}}}{e} ;$$

where ∂ is a human-computer interaction performance evaluation indicator, e is a natural constant, ρ is a user behavior interaction index, m₁ is a weight factor corresponding to the user behavior interaction index preset in an interaction database, di is a device interaction performance index, and m₂ is a weight factor corresponding to the device interaction performance index preset in the interaction database.

As a further optimization of the method, the optimizing the human-computer interaction performance of the human-computer interaction device is specifically analyzed as follows:
the human-computer interaction performance evaluation indicator is compared with a preset human-computer interaction performance evaluation indicator, and when the human-computer interaction performance evaluation indicator is less than or equal to the human-computer interaction performance evaluation indicator, there is no need to optimize the human-computer interaction performance of the human-computer interaction device.

When the human-computer interaction performance evaluation indicator is greater than a reference human-computer interaction performance evaluation indicator, the human-computer interaction performance evaluation indicator is matched with a human-computer interaction performance optimization solution corresponding to each preset human-computer interaction performance evaluation indicator interval to obtain the human-computer interaction performance optimization solution, and finally the human-computer interaction performance of the human-computer interaction device is optimized through the human-computer interaction performance optimization solution.

In a second aspect, the present disclosure provides a system for human-computer interaction performance evaluation based on virtual reality, and the system includes: a module for collecting and analyzing human-computer interaction data, configured for controlling a user to execute an interaction task through a human-computer interaction device in a virtual reality environment, collecting and analyzing behavioral data of the user during task execution, collecting and analyzing interaction data of the human-computer interaction device during task control, and deriving a user behavior interaction index and a device interaction performance index;
a module for evaluating human-computer interaction performance, configured for comprehensively analyzing the user behavior interaction index and the device interaction performance index to obtain a human-computer interaction performance evaluation indicator; and
a module for optimizing the human-computer interaction, configured for comparing the human-computer interaction performance evaluation indicator with a preset human-computer interaction performance evaluation indicator, matching a human-computer interaction performance optimization solution, and finally optimizing the human-computer interaction performance of the human-computer interaction device.

Compared with the prior art, the examples of the present disclosure have at least the following advantages or beneficial effects:
(1) The present disclosure collects and analyzes the behavioral data of the user during task execution, and the interaction data of the human-computer interaction device during task control, records operating behaviors of the user throughout the task execution in detail, and making an in-depth analysis of the operating behaviors of the user, thereby accurately identifying advantages and disadvantages in the interaction design; and analyzes the interaction data of the human-computer interaction device, evaluates a response speed, accuracy and processing efficiency of the human-computer interaction system, and identifies potential performance bottlenecks and makes improvements, which helps to improve overall performance and efficiency of the human-computer interaction system and ensure that the user can complete interaction tasks quickly and accurately.
(2) By evaluating the human-computer interaction performance, the present disclosure enables to timely discover problems and deficiencies in the design of the human-computer interaction system and identify the difficulties and bottlenecks encountered by the user during task execution in a virtual reality environment, thereby optimizing a human-computer interaction interface design, interaction logic and operation process, and improving the user's interaction experience in the virtual environment.
(3) The present disclosure optimizes the human-computer interaction performance of the human-computer interaction device through the human-computer interaction performance optimization solution, and the optimized human-computer interaction device enables to more accurately understand and execute user instructions and tasks and reduce erroneous interactions between the user and the device, thereby enhancing user satisfaction with human-computer interaction.

### BRIEF DESCRIPTION OF THE DRAWINGS

The present disclosure will be further described below with reference to the accompanying drawings, but the examples in the accompanying drawings do not constitute any limitation to the present disclosure. Those of ordinary skill in the art can also derive other accompanying drawings from the following accompanying drawings without making inventive efforts.

FIG. 1 is a flowchart illustrating steps of a method of the present disclosure.

FIG. 2 is a schematic diagram of connection of system modules of the present disclosure.

FIG. 3 is a simulation curve diagram showing a relationship between an interaction task execution completion duration and a device interaction performance index in the present disclosure.

### DETAILED DESCRIPTIONS OF THE EMBODIMENTS

The technical solutions of the embodiments of the present disclosure will be described below clearly and comprehensively in conjunction with accompanying drawings of the examples of the present disclosure. Apparently, the examples described are merely some examples rather than all examples of the present disclosure. Based on the examples of the present disclosure, all other examples obtained by the ordinary skill in the art without creative work fall within the scope of protection of the present disclosure.

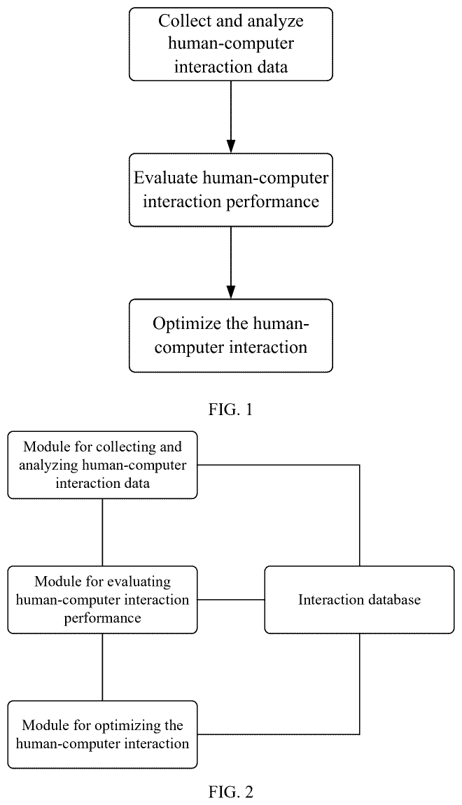

With reference to FIG. 1, in a first aspect, the present disclosure provides a method for human-computer interaction performance evaluation based on virtual reality, and the method includes: collect and analyze human-computer interaction data: in a virtual reality environment, control a user to execute an interaction task through a human-computer interaction device, collect and analyze behavioral data of the user during task execution, collect and analyze interaction data of the human-computer interaction device during task control, and derive a user behavior interaction index and a device interaction performance index.

Evaluate human-computer interaction performance: comprehensively analyze the user behavior interaction index and the device interaction performance index to obtain a human-computer interaction performance evaluation indicator.

Optimize the human-computer interaction: compare the human-computer interaction performance evaluation indicator with a preset human-computer interaction performance evaluation indicator, match a human-computer interaction performance optimization solution, and finally optimize the human-computer interaction performance of the human-computer interaction device.

Specifically, the behavioral data of the user during task execution specifically includes a total interaction duration of the user during task execution, the number of user interactions during task execution, a maximum heart rate of the user during task execution, and a respiratory rate of the user during task execution.

It should be noted that the total interaction duration of the user during task execution can be obtained by directly observing and recording time points when the user starts and ends the task during task execution and then calculating a difference between the two time points, the number of user interactions during task execution can be obtained by counting the number of user interactions during task execution through a statistical tool (such as Umeng), the maximum heart rate of the user during task execution is obtained by monitoring the user's heart rates during task execution in real time through an electrocardiogram (ECG) monitor, sorting the recorded heart rates in a descending order, and finally extracting a maximum heart rate of the user during task execution, and the respiratory rate of the user during task execution can be obtained by measuring breathing times of the user during task execution in real time through a respiratory frequency sensor.

Specifically, the analyzing behavioral data of the user during task execution specifically includes the following steps:
compare the number of user interactions during task execution with the total interaction duration of the user during task execution to obtain interaction efficiency of the user during task execution.

Divide the respiratory rate of the user during task execution by the total interaction duration of the user during task execution to obtain an average respiratory rate of the user during task execution.

Further, the user behavior interaction index is specifically analyzed as follows:
the interaction efficiency of the user during task execution, the maximum heart rate of the user during task execution, and an average respiratory rate of the user during task execution are comprehensively analyzed to obtain the user behavior interaction index, with a specific analysis formula as follows:

$$ρ = \sqrt{\frac{\vert yt - Δ yt \vert}{Δ y t} * {x}_{1} + \frac{\vert yo - Δ yo \vert}{Δ y o} * {x}_{2} + \frac{\vert yh - Δ yh \vert}{Δ y h} * {x}_{3} + 1} ;$$

where ρ is a user behavior interaction index; when the interaction efficiency of the user is low during task execution, the user may need more time to complete interaction tasks, such that the user will have less satisfaction and trust in human-computer interaction and even gradually deceasing willingness in human-computer interaction, and moreover, a too high heart rate of the user during task execution may pose significant physiological stress to the user. The stress could lead to discomfort, fatigue, or anxiety of the user, compromise an interaction effect and satisfaction of the user in the virtual environment. Moreover, the user with a high heart rate can hardly maintain concentration, such that the user may make more errors during task execution, and the user's interaction behaviors in the virtual environment may be impeded. For example, the user may hardly operate a device such as a handle or a head-mounted display due to sweating or nervousness, which will adversely affect exploration and interaction of the user in the virtual environment. When the average respiratory rate of the user during task execution exceeds a preset average reference respiratory rate for the user, the user may experience significant physiological stress, and the stress may cause discomfort of the user and affect the user's performance during task execution, e.g., the user can hardly maintain concentration and may make more errors during operation. Therefore, by analyzing various data of the user behavior interaction index, the present disclosure enables to identify the difficulties and bottlenecks encountered by the user when executing interaction tasks, optimize an interaction task process, reduce operational difficulty of interaction, and identify advantages and disadvantages in the interaction design.

It should be noted that in this example, the interaction efficiency of the user during task execution, the maximum heart rate of the user during task execution, and the average respiratory rate of the user during task execution are expressed in a nonlinear manner, to comprehensively evaluate the interaction efficiency of the user during task execution, physiological reactions (such as heart rate changes) and physiological states (such as a respiratory rate). The comprehensive evaluation enables to more comprehensively reflect overall quality of experience when the user uses a device or system, instead of reflecting a single indicator only. Through nonlinear operations, complex relationships between indicators and interaction effects can be captured. For example, the relationships between the interaction efficiency, heart rate and respiratory rate of the user maybe are not merely linear but exhibit nonlinear complexities. The nonlinear operations enable to describe and quantify these complex relationships more accurately, thereby improving precision and accuracy of evaluation.
yt represents interaction efficiency of the user during task execution, which quantifies a relationship between time consumed by the user to execute an interaction task and the number of interactions.
Δyt represents reference interaction efficiency preset in an interaction database, which refers to reference efficiency of the user when executing an interaction task.
x₁ is a correction factor corresponding to the interaction efficiency preset in the interaction database, which refers to a parameter used to adjust the interaction efficiency when evaluating and optimizing a human-computer interaction system. Specifically, a corresponding relationship between a historical human-computer interaction duration and the interaction efficiency is fitted to obtain a fitting curve corresponding to the interaction efficiency, and then a real-time human-computer interaction duration is input into the fitting curve corresponding to the interaction efficiency to obtain the correction factor corresponding to the interaction efficiency in this example, with a value range of (0, 1).
yo is a maximum heart rate of the user during task execution, which refers to a maximum value of the user's actual heart rate monitored during execution of an interaction task.
Δyo is a reference heart rate preset in the interaction database, which refers to a reference heart rate preset for the user when executing an interaction task.
x₂ is a correction factor corresponding to the reference heart rate of the user preset in the interaction database, which refers to a degree of influence that heart rate changes of the user have on the user behavior interaction index. Specifically, a corresponding relationship between a historical human-computer interaction duration, a historical age and heart rate of the user is fitted to obtain a fitting curve corresponding to the heart rate of the user, and then a real-time human-computer interaction duration and the age of the user are input into the fitting curve corresponding to the heart rate of the user to obtain the correction factor corresponding to the heart rate of the user in this example, with a value range of (0, 1).

yh is an average respiratory rate of the user during task execution, which refers to an average number of breaths per minute measured when the user executes an interaction task.
Δyh is an average reference respiratory rate of the user preset in the interaction database, which refers to a benchmark value of the user's respiratory rate when the user executes an interaction task.
x₃ is a correction factor corresponding to the reference respiratory rate of the user preset in the interaction database, which refers to a degree of influence that respiratory rate changes of the user have on the user behavior interaction index. Specifically, a corresponding relationship between a historical user interaction duration and a respiratory rate of the user is fitted to obtain a fitting curve corresponding to the respiratory rate of the user, and then a real-time human-computer interaction duration is input into the fitting curve corresponding to the respiratory rate of the user to obtain the correction factor corresponding to the respiratory rate of the user in this example, with a value range of (0, 1).

It should be noted that the changes in the maximum heart rate of the user and the average respiratory rate of the user during task execution are related to a specific interaction task. Table 1 below shows maximum heart rates and average respiratory rates of users collected during execution of different virtual tasks.

TABLE 1
Heart rates and respiratory rates of users

| | | | Average respiratory |
|---|---|---|---|
| User | | Maximum heart rate | rate (breaths per |
| ID | Task type | (beats per minute) | minute) |
| 1 | Navigation | 120 | 22 |
| 2 | Puzzle-solving | 130 | 24 |
| 3 | Shooting game | 145 | 28 |
| 4 | Simulation driving | 115 | 20 |
| 5 | Flight simulation | 135 | 26 |
| 6 | Sports competition | 150 | 30 |
| 7 | Educational learning | 100 | 18 |
| 8 | Artistic creation | 95 | 16 |

Analysis of the data in Table 1 reveals that different types of tasks have significant impacts on users' physiological responses. For example, the users executing dynamic or stressful tasks such as shooting games, puzzle-solving tasks and sports competitions have higher maximum heart rates and average respiratory rates, while the users executing more static and relaxing tasks such as educational learning and artistic creation have relatively low maximum heart rates and average respiratory rates. Different users show different physiological responses to a same task, which may be related to their respective physical conditions, experience, ages and personal backgrounds. The data suggests a possible positive correlation between the maximum heart rate and the average respiratory rate, that is, the respiratory rate tends to rise with an increase in the heart rate, which reflects physiological adjustments of the user when carrying out a more tense or intense activity.

Specifically, the interaction data of the human-computer interaction device during the task control specifically includes: a task interaction response duration of the human-computer interaction device, a task interaction execution duration, a total number of interaction tasks executed, the number of interaction tasks properly executed, and a duration when interaction tasks are properly executed during the task control.

It should be noted that the task interaction response duration of the human-computer interaction device, the task interaction execution duration, the total number of interaction tasks executed, the number of interaction tasks properly executed, and the duration when interaction tasks are properly executed during the task control can all be obtained from relevant recorded data in human-computer interaction logs of the human-computer interaction system.

Specifically, the analyzing interaction data of the human-computer interaction device during task control specifically includes the following steps:

Sum the task interaction response duration of the human-computer interaction device and the task interaction execution duration during task control, to obtain an interaction task execution completion duration.

Calculate a ratio of the number of interaction tasks properly executed to the total number of interaction tasks executed to obtain an interaction task execution accuracy rate.

Divide the duration when interaction tasks are properly executed by the interaction task execution completion duration to obtain an interaction task execution time accuracy rate.

Further, the device interaction performance index is specifically analyzed as follows:
the interaction task execution completion duration, the interaction task execution accuracy rate, and the interaction task execution time accuracy rate are comprehensively processed to obtain the device interaction performance index, with a specific analysis formula as follows:

$$di = lg ( \frac{\vert dt - Δ dt \vert}{Δ d t} * {h}_{1} + \frac{\vert dr - Δ dr \vert}{Δ d r} * {h}_{2} + \frac{\vert dp - Δ dp \vert}{Δ d p} * {h}_{3} + 1 ) ;$$

where di is a device interaction performance index. A longer interaction task execution completion duration indicates that time required for the user to complete a specific interaction task is too long. When the user is waiting for completion of a task, time perceived by him/her is usually longer than an actual duration, which will lead to user dissatisfaction and further reduce the interaction task execution accuracy rate. Moreover, frequent errors of the device during interaction necessitate repeated corrections such as revocation and modification, such that the user has to repeatedly execute the interaction task, thereby increasing complexity of interaction. In order to correct errors, the user needs to spend more time in interactions, and the operations impose extra burdens on the user, thereby prolonging single-task execution and causing other tasks to be delayed, such that overall efficiency is impaired. Extended waiting for completion of a task may hinder effective task-switching, and increase time costs. Therefore, by analyzing various data of the device interaction performance index, the present disclosure enables to evaluate a response speed, accuracy and processing efficiency of the human-computer interaction system, which helps to improve overall performance and efficiency of the human-computer interaction system and ensure that the user can complete interaction tasks quickly and accurately.

It should be noted that in this example, nonlinear representation of the interaction task execution completion duration, the interaction task execution accuracy rate and the interaction task execution time accuracy rate enables to more comprehensively reflect the performance of the device in actual use, not only with a focus on a speed of task completion, but also in consideration of task execution accuracy rate and task execution time accuracy rate. Nonlinear expression enables to capture possible complex relationships and mutual influences between the task completion duration, accuracy rate and time accuracy rate. For example, when the task completion duration is short, change trends of the accuracy rate or time accuracy rate are not merely linear, and the nonlinear expression enables to more accurately describe and quantify these complex interaction characteristics.
dt represents an interaction task execution completion duration, which refers to a total duration from start of an interaction task to completion of the interaction task.
Δdt represents a reference interaction task execution completion duration preset in the interaction database, which refers to a maximum allowable duration for completing the interaction task.
h₁ is a correction factor corresponding to the interaction task execution completion duration preset in the interaction database, which refers to a degree of influence of the interaction task execution completion duration on the device interaction performance index. Specifically, a corresponding relationship between the number of historical interaction tasks and the interaction task execution completion duration is fitted to obtain a fitting curve corresponding to the interaction task execution completion duration, and then a real-time number of interaction tasks is input into the fitting curve corresponding to the interaction task execution completion duration to obtain the correction factor corresponding to the interaction task execution completion duration in this example, with a value range of (0, 1).
dr represents an interaction task execution accuracy rate, which refers to a proportion of properly executed interaction tasks in completed interaction tasks.
Δdr represents a reference interaction task execution accuracy rate preset in the interaction database, which refers to a target accuracy rate of properly executing interaction tasks, and is used to measure the operational accuracy of completing specific interaction tasks by the user under normal circumstances.
h₂ is a correction factor corresponding to the interaction task execution accuracy rate preset in the interaction database, which refers to a degree of influence of the interaction task execution accuracy rate on the device interaction perform index. Specifically, a corresponding relationship between the number of historical interaction tasks properly executed and the interaction task execution accuracy rate is fitted to obtain a fitting curve corresponding to the interaction task execution accuracy rate, and then a real-time number of interaction tasks properly executed is input into the fitting curve corresponding to the interaction task execution accuracy rate to obtain the correction factor corresponding to the interaction task execution accuracy rate in this example, with a value range of (0, 1).
dp represents an interaction task execution time accuracy rate, which refers to a proportion of time for properly executing interaction tasks to total interaction task execution time.
Δdp represents a reference interaction task execution time accuracy rate preset in the interaction database, which refers to a reference proportion of time for properly executing interaction tasks to total interaction task execution time.
h₃ is a correction factor corresponding to the interaction task execution time accuracy rate preset in the interaction database, which refers to a degree of influence of the interaction task execution time accuracy rate on the device interaction perform index. Specifically, a corresponding relationship between a duration of properly executing historical interaction tasks and the interaction task execution time accuracy rate is fitted to obtain a fitting curve corresponding to the interaction task execution time accuracy rate, and then a real-time duration of properly executing interaction tasks is input into the fitting curve corresponding to the interaction task execution time accuracy rate to obtain the correction factor corresponding to the interaction task execution time accuracy rate in this example, with a value range of (0, 1).

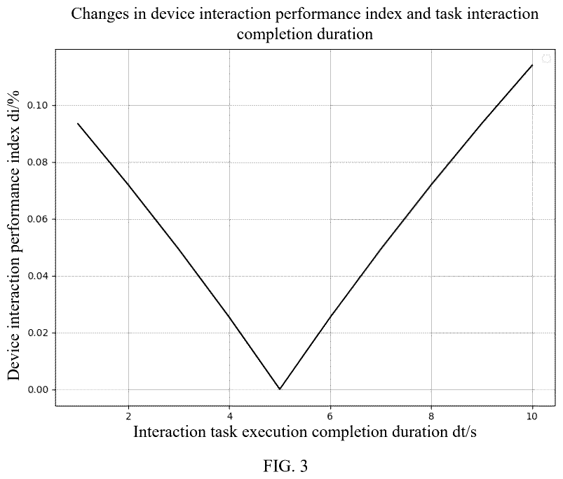

In this example, a simulation curve consisting of the above interaction task execution completion duration and the device interaction performance index is shown in FIG. 3, where a horizontal axis of FIG. 3 represents an interaction task execution completion duration dt n seconds, and a vertical axis represents a device interaction performance index di in percentage (%).

The simulation curve constructed in FIG. 3 intuitively shows that a changing trend of di (the device interaction performance index) with an increase of dt (the interaction task execution completion duration). Specifically, the device interaction performance index shows a trend of initially increasing and then decreasing as the interaction task execution completion duration increases, because the increase in the interaction task execution completion duration may prolong the task execution completion duration, thereby affecting the overall interaction performance index.

Specifically, the human-computer interaction performance evaluation indicator is specifically analyzed as follows:
the user behavior interaction index and the device interaction performance index are comprehensively analyzed to obtain the human-computer interaction performance evaluation indicator, with a specific analysis formula as follows:

$$\partial = \frac{{e}^{ρ * {m}_{1}} + {e}^{d i * {m}_{2}}}{e} ;$$

where ∂ is a human-computer interaction performance evaluation indicator. A lower interaction index maybe indicates a higher likelihood of user misoperation or an increased probability of operational errors, which will not only increase time costs of completing tasks, but also will cause some unnecessary problems or risks, such as an increased possibility of data input errors or device damage. A low interaction performance index of the device means that the device responds slowly to user instructions, execution instructions and the like, such that the user needs to spend more time and efforts to complete tasks, thereby reducing interaction efficiency. Additionally, this may indicate that the device has defects in stability and reliability. Therefore, by analyzing various data in the human-computer interaction performance evaluation indicator, the present disclosure enables to timely discover problems and deficiencies in the design of the human-computer interaction system and identify difficulties and bottlenecks encountered by the user during task execution in a virtual reality environment, so as to optimize a human-computer interaction interface design, interaction logic and operation process, and improve the user's interaction experience in the virtual environment.
e is a natural constant, ρ is a user behavior interaction index, and di is the device interaction performance index.
m₁ is a weight factor corresponding to the user behavior interaction index preset in the interaction database, and m₂ is a weight factor corresponding to the device interaction performance index preset in the interaction database.

It should be noted that the weight factor corresponding to the user behavior interaction index refers to a degree of influence of changes in the user behavior interaction index on the human-computer interaction performance evaluation indicator. Specifically, a corresponding relationship between a historical interaction duration, a historical heart rate and a historical respiratory rate of the user and the user behavior interaction index is fitted to obtain a fitting curve corresponding to the user behavior interaction index, and then a real-time interaction duration, heart rate and respiratory rate of the user are input into the fitting curve corresponding to the user behavior interaction index to obtain the weight factor corresponding to the user behavior interaction index in this example, with a value range of (0, 1). The weight factor corresponding to the device interaction performance index refers to a degree of influence of changes in the device interaction performance index on the human-computer interaction performance evaluation indicator. Specifically, a corresponding relationship between a historical interaction duration, a historical interaction accuracy and the device interaction performance index is fitted to obtain a fitting curve corresponding to the device interaction performance index, and then a real-time interaction duration and interaction accuracy are input into the fitting curve corresponding to the device interaction performance index to obtain the weight factor corresponding to the device interaction performance index in this example, with a value range of (0, 1). In this example, the above m₁+m₂=1, the weight factor m₁ corresponding to the user behavior interaction index is set to 0.4, and the weight factor corresponding to the device interaction performance index is set to 0.6. The values of the human-computer interaction performance evaluation indicator in this example are shown in Table 2:

TABLE 2
Human-computer interaction performance evaluation indicator

| User behavior | | Human-computer interaction |
|---|---|---|
| interaction | Device interaction | performance evaluation |
| index ρ/% | performance index di/% | indicator ∂/% |
| 60 | 50 | 96.4 |
| 30 | 20 | 83 |
| 80 | 100 | 118 |
| 20 | 10 | 78.9 |

Results of analyzing the human-computer interaction performance evaluation indicator in Table 2 above show that the human-computer interaction performance evaluation indicator exhibits a directly proportional relationship with ∂ the user behavior interaction index ρ and the device interaction performance index di. The human-computer interaction performance evaluation indicator ∂ will change accordingly with changes in the user behavior interaction index ρ and the device interaction performance index di. For example, when the user behavior interaction index ρ is 80 and the device interaction performance index di is 100, the human-computer interaction performance evaluation indicator ∂ is 118, and when the user behavior interaction index ρ is 20 and the device interaction performance index di is 10, the human-computer interaction performance evaluation indicator ∂ is 78.9. That is, when the user behavior interaction index ρ and the device interaction performance index di are larger, the corresponding human-computer interaction performance evaluation indicator ∂ will also be larger, and when the user behavior interaction index ρ and the device interaction performance index di are smaller, the corresponding human-computer interaction performance evaluation indicator ∂ will also be smaller.

Specifically, the optimizing the human-computer interaction performance of the human-computer interaction device is specifically analyzed as follows:
the human-computer interaction performance evaluation indicator is compared with a preset human-computer interaction performance evaluation indicator, and when the human-computer interaction performance evaluation indicator is less than or equal to the human-computer interaction performance evaluation indicator, there is no need to optimize the human-computer interaction performance of the human-computer interaction device.

It should be noted that the above preset human-computer interaction performance evaluation indicator refers to a maximum value of the human-computer interaction performance evaluation indicator, which can be obtained by referring to historical human-computer interaction performance evaluation indicators and consulting literature related to human-computer interaction performance evaluation. In this example, the human-computer interaction performance evaluation indicator is set to 60.
when the human-computer interaction performance evaluation indicator is greater than a reference human-computer interaction performance evaluation indicator, the human-computer interaction performance evaluation indicator is matched with a human-computer interaction performance optimization solution corresponding to each preset human-computer interaction performance evaluation indicator interval to obtain the human-computer interaction performance optimization solution, and finally the human-computer interaction performance of the human-computer interaction device is optimized through the human-computer interaction performance optimization solution.

It should be noted that the each preset human-computer interaction performance evaluation indicator interval is obtained by comprehensively analyzing massive historical manual interaction performance evaluation data and actual human-computer interaction performance data.

The above human-computer interaction performance evaluation indicator is matched with a human-computer interaction performance optimization solution corresponding to each preset human-computer interaction performance evaluation indicator interval, and a specific matching method is as follows:

When the human-computer interaction performance evaluation indicator is (60,80], it is classified as an acceptable interval, and when the human-computer interaction performance evaluation indicator is greater than 80, it is classified as a poor interval. When an interval corresponding to the human-computer interaction performance evaluation indicator is the acceptable interval, it means that there exists a bottleneck in performance of the current human-computer interaction, and targeted improvement measures are specified according to the performance bottleneck of the human-computer interaction to improve efficiency of the human-computer interaction. When an interval corresponding to the human-computer interaction performance evaluation indicator is the poor interval, serious problems that affect the user experience should be handled immediately to minimize a negative impact, the human-computer interaction system should be comprehensively reviewed to identify root causes of poor performance, and the human-computer interaction system testing and user experience testing should be enhanced to ensure that the problems are solved and avoid similar problems from occurring again.

With reference to FIG. 2, in a second aspect, the present disclosure provides A system applying the method for human-computer interaction performance evaluation based on virtual reality, and the system includes: a module for collecting and analyzing human-computer interaction data, a module for evaluating human-computer interaction performance, and a module for optimizing the human-computer interaction.

The module for collecting and analyzing human-computer interaction data is connected to the module for evaluating human-computer interaction performance, the module for evaluating human-computer interaction performance is connected to the module for optimizing the human-computer interaction, and the module for collecting and analyzing human-computer interaction data, the module for evaluating human-computer interaction performance, and the module for optimizing the human-computer interaction are all connected to the interaction database.

The module for collecting and analyzing human-computer interaction data, is configured for controlling a user to execute an interaction task through a human-computer interaction device in a virtual reality environment, collecting and analyzing behavioral data of the user during task execution, collecting and analyzing interaction data of the human-computer interaction device during task control, and deriving a user behavior interaction index and a device interaction performance index.

The module for evaluating human-computer interaction performance, is configured for comprehensively analyzing the user behavior interaction index and the device interaction performance index to obtain a human-computer interaction performance evaluation indicator.

The module for optimizing the human-computer interaction, is configured for comparing the human-computer interaction performance evaluation indicator with a preset human-computer interaction performance evaluation indicator, matching a human-computer interaction performance optimization solution, and finally optimizing the human-computer interaction performance of the human-computer interaction device.

In a second aspect, the present disclosure provides A system applying the method for human-computer interaction performance evaluation based on virtual reality, and the system further includes an interaction database for storing a preset reference interaction efficiency, a preset correction factor corresponding to the interaction efficiency, a preset reference heart rate, a preset correction factor corresponding to the heart rate, a preset average reference respiratory rate, a preset correction factor corresponding to the respiratory rate, a preset reference interaction task execution completion duration, a correction factor corresponding to the interaction task execution completion duration preset in the interaction database, a preset reference interaction task execution accuracy rate, a preset correction factor corresponding to the interaction task execution accuracy rate, a preset reference interaction task execution time accuracy rate, a preset correction factor corresponding to the interaction task execution time accuracy rate, a preset weight factor corresponding to the user behavior interaction index, a preset weight factor corresponding to the device interaction performance index, and a preset human-computer interaction performance optimization solution corresponding to each preset human-computer interaction performance evaluation indicator interval.

The above contents are merely examples and descriptions of a structure of the present disclosure. Those skilled in the art to which the present disclosure pertains can make various modifications or additions to the specific examples described or replace same in a similar manner, as long as they do not deviate from the structure of the present disclosure or go beyond the scope defined by the specification. All should fall within the scope of protection of the present disclosure.

1. A computer-implemented method for human-computer interaction performance evaluation based on virtual reality, comprising:
collecting and analyzing human-computer interaction data from a human-computer interaction system: in a virtual reality environment, controlling a user to execute an interaction task through a human-computer interaction device, collecting and analyzing behavioral data of the user during task execution, collecting and analyzing interaction data of the human-computer interaction device during task control, and deriving a user behavior interaction index and a device interaction performance index;
evaluating human-computer interaction performance: analyzing the user behavior interaction index and the device interaction performance index to obtain a human-computer interaction performance evaluation indicator;
optimizing the human-computer interaction: comparing and matching the human-computer interaction performance evaluation indicator with a preset human-computer interaction performance evaluation indicator, to obtain a human-computer interaction performance optimization solution, and finally optimizing the human-computer interaction system based on the human-computer interaction performance optimization solution to improve the human-computer interaction performance of the human-computer interaction device;
wherein the human-computer interaction system is a system software of the human-computer interaction device;
the user behavior interaction index is analyzed as follows:
interaction efficiency of the user during task execution, a maximum heart rate of the user during task execution, and an average respiratory rate of the user during task execution are analyzed to obtain the user behavior interaction index, with an analysis formula as follows:
$$ρ = \sqrt{\frac{\vert yt - Δ yt \vert}{Δ y t} * {x}_{1} + \frac{\vert yo - Δ yo \vert}{Δ y o} * {x}_{2} + \frac{\vert yh - Δ yh \vert}{Δ y h} * {x}_{3} + 1} ;$$
in the formula, ρ is a user behavior interaction index, yt represents interaction efficiency of the user during task execution, Δyt represents reference interaction efficiency preset in an interaction database, x₁ is a correction factor corresponding to the interaction efficiency preset in the interaction database, yo is a maximum heart rate of the user during task execution, Δyo is a reference heart rate preset in the interaction database, x₂ is a correction factor corresponding to the reference heart rate of the user preset in the interaction database, yh is an average respiratory rate of the user during task execution, Δyh is an average reference respiratory rate of the user preset in the interaction database, and x₃ is a correction factor corresponding to the reference respiratory rate of the user preset in the interaction database;
an interaction task execution completion duration, an interaction task execution accuracy rate, and an interaction task execution time accuracy rate are processed to obtain the device interaction performance index, with an analysis formula as follows:
$$d i = l g ( \frac{\vert dt - Δ dt \vert}{Δ d t} * {h}_{1} + \frac{\vert dr - Δ dr \vert}{Δ dr} * {h}_{2} + \frac{\vert dp - Δ dp \vert}{Δ d p} * {h}_{3} + 1 ) ;$$
in the formula, di is a device interaction performance index, dt represents an interaction task execution completion duration, Δdt represents a reference interaction task execution completion duration preset in the interaction database, h₁ is a correction factor corresponding to the interaction task execution completion duration preset in the interaction database, dr represents an interaction task execution accuracy rate, Δdr represents a reference interaction task execution accuracy rate preset in the interaction database, h₂ is a correction factor corresponding to the interaction task execution accuracy rate preset in the interaction database, dp is an interaction task execution time accuracy rate, Δdp represents a reference interaction task execution time accuracy rate preset in the interaction database, and h₃ is a correction factor corresponding to the interaction task execution time accuracy rate preset in the interaction database;
the human-computer interaction performance evaluation indicator is analyzed as follows:
the user behavior interaction index and the device interaction performance index are analyzed to obtain the human-computer interaction performance evaluation indicator, with a specific analysis formula as follows:
$$\partial = \frac{{e}^{ρ * {m}_{1}} + {e}^{d i * {m}_{2}}}{e} ;$$
in the formula, ∂ is a human-computer interaction performance evaluation indicator, e is a natural constant, ρ is a user behavior interaction index, m₁ is a weight factor corresponding to the user behavior interaction index preset in an interaction database, di is a device interaction performance index, and m₂ is a weight factor corresponding to the device interaction performance index preset in the interaction database.

2. The computer-implemented method for human-computer interaction performance evaluation based on virtual reality according to claim 1, wherein the behavioral data of the user during task execution comprises a total interaction duration of the user during task execution, the number of user interactions during task execution, a maximum heart rate of the user during task execution, which is monitored by an electrocardiogram (ECG) monitor, and a respiratory rate of the user during task execution, which is measured by a respiratory frequency sensor.

3. The computer-implemented method for human-computer interaction performance evaluation based on virtual reality according to claim 2, wherein the analyzing behavioral data of the user during task execution comprises the following steps:
comparing the number of user interactions during task execution with the total interaction duration of the user during task execution to obtain the interaction efficiency of the user during task execution; and
dividing the respiratory rate of the user during task execution by the total interaction duration of the user during task execution to obtain an average respiratory rate of the user during task execution.

4. The computer-implemented method for human-computer interaction performance evaluation based on virtual reality according to claim 1, wherein the interaction data of the human-computer interaction device during the task control comprises: a task interaction response duration of the human-computer interaction device, a task interaction execution duration, a total number of interaction tasks executed, the number of interaction tasks properly executed, and a duration when interaction tasks are properly executed during the task control.

5. The computer-implemented method for human-computer interaction performance evaluation based on virtual reality according to claim 1, wherein the analyzing interaction data of the human-computer interaction device during task control comprises the following steps:
summing the task interaction response duration of the human-computer interaction device and the task interaction execution duration during task control, to obtain an interaction task execution completion duration;
calculating a ratio of the number of interaction tasks properly executed to the total number of interaction tasks executed to obtain an interaction task execution accuracy rate; and
dividing the duration when interaction tasks are properly executed by the interaction task execution completion duration to obtain an interaction task execution time accuracy rate.

6. The computer-implemented method for human-computer interaction performance evaluation based on virtual reality according to claim 1, wherein the optimizing the human-computer interaction system is analyzed as follows:
the human-computer interaction performance evaluation indicator is compared with a preset human-computer interaction performance evaluation indicator, and when the human-computer interaction performance evaluation indicator is less than or equal to the human-computer interaction performance evaluation indicator, there is no need to optimize the human-computer interaction system; and
when the human-computer interaction performance evaluation indicator is greater than a reference human-computer interaction performance evaluation indicator, the human-computer interaction performance evaluation indicator is matched with a human-computer interaction performance optimization solution corresponding to each preset human-computer interaction performance evaluation indicator interval to obtain the human-computer interaction performance optimization solution, and finally the human-computer interaction system is optimized through the human-computer interaction performance optimization solution.

7. (canceled)
